(19) United States
(12) Patent Application Publication
(10) Pub. No.: US 2020/0051166 A1
(43) Pub. Date: Feb. 13, 2020

(54) SYSTEM AND METHOD FOR TRADING ASSETS AMONG PARTIES THROUGH TOKENIZATION OF ASSETS

(71) Applicant: TICKETSOCKET KOREA Co., Ltd., Seoul (KR)

(72) Inventors: Myoung Gene LOH, Seoul (KR); Si Youn SONG, Seoul (KR)

(73) Assignee: TICKETSOCKET KOREA Co., Ltd., Seoul (KR)

(21) Appl. No.: 16/194,207

(22) Filed: Nov. 16, 2018

(30) Foreign Application Priority Data
Aug. 13, 2018 (KR) 10-2018-0094272

(51) Int. Cl. G06Q 40/04; G06Q 30/02; H04L 9/06

(52) U.S. Cl. CPC G06Q 40/04; H04L 9/0637; G06Q 30/0283

(57) ABSTRACT

The present disclosure relates to an assets trading system among parties through tokenization of assets including an asset evaluation server for evaluating a value of an asset and computing an evaluated amount of the asset; an asset liquidization server for issuing a token corresponding to the computed evaluated amount, and managing rights and dividends regarding the issued token; a token trading bulletin board providing a token trading bulletin board where a seller intending to sell the issued token and a purchaser intending to purchase the issued token can directly trade with each other; an escrow server for mediating sales of the token between the potential seller and the potential purchaser; and a blockchain possessed server having a blockchain for certifying trading of the token and where trading information regarding the certified trade is recorded.

### TECHNICAL FIELD

The present invention relates to an assets trading system and method among parties through tokenization of assets, and more particularly, to an assets trading system and method for tokenizing the assets to enable direct sales trading of the assets among the parties that have been divided into multiple tokens.

### BACKGROUND OF THE INVENTION

Real estate is generally high-priced, and highly individual and local, and thus has a characteristic that when investing in real estate not only a significant amount of fund but also professional knowledge and experience are necessary. Furthermore, relatively large trading volume, with extremely low monetary realization and liquidity are also characteristics of real estate. Accordingly, when the real estate market is in stagnation, there is a rapid increase in properties put on the market due to the need to resolve financial difficulty and restructuring of companies along with unemployment. However, it is impossible to sell these properties, which becomes a serious stumbling block in the restructuring process of companies. This increases the amount of insolvent bonds in financial institutions and leads to even fewer tradings. And the real estate prices might plummet. Whereas, even during a market boom, it is difficult for small investors to enter the market, due to its large trading volume and low liquidity, leading to distortion of the market by speculative capital.

In order to overcome such characteristics of the real estate market, products made by grafting the real estate market onto financial markets, such as real estate funds and REITS, have been released, but the utilization rate is not high due to other alternative investment products having high liquidities and profitability. Besides, real estate funds and REITS are indirect real estate investment means where the funds raised for property investment purposes are run by experts, and any profit incurred therefrom is divided up among the investors. Therefore, consequently, the investors have no choice but to depend on the decisions made by the experts who run the funds, which is a problem.

In the end, direct investment method which is based on transfer of ownership has a problem since it might impose a heavy strain on the investors in terms of the investment amount, various progressive taxes, and trading-related taxes while existing real estate financial products involving trading of equities only make it impossible to invest into the wanted properties, eventually reducing the investors' investment confidence. Meanwhile, even in situations where there is the infrastructure to easily access real estate related information due to the development of communication means, people are going no more further than using only the information on real estate trends fragmentarily to look up market prices and properties for them to move or invest into.

Recently, a new method has been developed as a means to make payments for kind: using virtual currencies such as Bitcoins (BTC) or Ethereum (ETH). These virtual currencies are called crypto currencies or virtual currencies. It is a general term for all kinds of digital trading means that use the block chain distributed ledger technology where, instead of controlling the trading ledgers in the center, records of tradings between owners are distributed and recorded in a digital block form, and new blocks and existing blocks are connected in a hash form to prevent the trading contents from being hacked. It uses coin units.

The Bitcoin (BTC), known as the first block chain-based virtual currency means, is an encoded digital currency that an inventor called alias Satoshi Nakamoto invented based on the White Paper, ‘Bitcoin: A peer-to-Peer Electronic Cash System’. It consists of a structure where there is no central device for issuing and managing the currency.

Instead, Bitcoin tradings are made by a distributed database which is based on a P2P (peer-to-peer network) and also based on an open key code method. Further, Bitcoins are stored in the form of wallet files where each one is granted a different address, that is a public address, and a private key, which is a password. It is based on this public address that Bitcoin tradings are made as sales and purchase trading.

Besides Bitcoins, there are various kinds of virtual currencies that are used as means for making payments for kinds: Ethereum, cardano (ADA) and Ripple (XRP). What these have in common is that the list of tradings of coins including Bitcoins are shared through the block chain distributed ledgers to prevent hacking.

Methods for possessing such coins that have payment characteristics as aforementioned include purchasing methods and mining methods that require direct participation in creating the coins. In a purchasing method, a user would generally subscribe to a coin exchange, open an electronic wallet and charge the wallet with KRW and purchase the coins at the coin exchange at the market price. There are also issuance type coins that are coins issued by certain companies and that can be purchased by paying to those companies.

In the case of mining coins, when a computer designed for special purposes aimed at possessing certain coins is bought and connected online to a digital network configuring coins, the computer is connected to the existing network system via a new node, contributing to the performance and stability of the existing network. And after a joint participation is made in deciphering a complex coin code in the new network, when the code is deciphered, new coins are generated (this is process is generally called mining). These newly generated coins are rewarded by the hash power that the participator provided for the joint operation, and since these coins are rewarded according to the contributed operation, they are usually called Proof of Work (POW).

Thereafter, upon confirming the current market price of the coins being traded at the coin exchange and then inputting the amount and unit price of the coins to be purchased, when a purchase order is made, a trading is established through a sales order that matches the trading conditions, or a direct trading is made using a personal electronic wallet that is unique to the coin holders.

However, in the case of trading through the coin exchange, since the sellers and buyers of the coins are members of the centralized coin exchange, the sales become simple and fast, but coin holders may become too dependent on the coin exchange, and there is a problem that should the centralized exchange be hacked, member information of the coin holders and personal information may leak and the coins held by the exchange may be robbed.

Direct coin trading between individuals does not pose such a risk, but as the number of coin traders increases, generating blocks, that is recording the trading records get delayed, thereby leading to slower trading speed. And there is also a problem that once a person loses the electronic wallet information of the coins that he/she possesses, there is no way to find the information since the block chain is decentralized.

Due to these problems, in the case of block chain based coins, there is an inherent limitation when they are to be used as a direct payment means of sales because when there are many users, trading speed may decrease due to the characteristics of the block chain, whereas, when using the centralized exchange, there is the risk of various hacking along with the limitations of being restricted to tradings between only the members, that is especially, a limitation that basic functions such as payment cancellation, correction, and refund that are frequently seen in general payment processes cannot be performed.

Furthermore, it is impossible to guarantee reliability regarding settlement of payment and provision of the payment that are basic functions of a payment process, and reliability regarding provision of coins cannot but be determined and chosen by the seller. Furthermore, price volatility is severe during the time spent in the payment process, and thus coins cannot be acknowledged as a stable sales means like money but go no further than catching the intention of reliable holders in the trading market of digital assets as an investment means.

Due to these limitations, when doing a sales trading with coins, instead of using them directly as a payment means, there is no way but to use the detour method, that is, when a sales trading between individuals is finalized, simply transmitting the coins through the exchange or prepaying the coins by an agency before the coin trading is completed based on the form of exchanging coins mutually accepted as a payment means. Furthermore, coins can only be used as trading means and not payment means.

### SUMMARY OF THE DISCLOSURE

Along with the aforementioned problems, existing virtual currencies are based on data that does not have any substance, and thus cannot have the function as a security of an actual asset, Furthermore, existing virtual currencies are in the form of having the function of asset as they are converted based on the market prices formed through sales established based on the trust between the traders, and thus when that trust of sales between the traders is destroyed or the company or foundation that issued the virtual currencies becomes insolvent, the assets of the virtual currency holders cannot be protected.

Along with the aforementioned problems, in the case of the mining type Proof of Work (POW) method coins that account for a large number of the many types of the existing virtual currencies, if compared to the values of the coins newly rewarded to the participants who connect their computers in order to be distributed with newly generated coins in a digital network the computer purchase cost and repair and maintenance fee such as electricity fee and the like that is input to be distributed with those coins is insufficient, users who break away from participation will increase, and this will undermine the driving force of the system that intended to expand the performance and stability of the network by rewarding new coins being generated by deciphering the codes thereby increasing participants consistently. There is an inherent risk that if the pace the existing participants break away from the node is accelerated, the network, which is the block chain that generates and distributes the blocks for stable trading of the coins can be destroyed.

Furthermore, in such a mining type block chain system, multiple users are dispersed to provide the network hash power and hold one other in check to prevent them from hacking the trading ledger blocks thereby maintaining stability. And such a system cannot be regarded safe from the risk of hacking maliciously attempted by a concentrated user having 51% or more hash power of the entire network to the entire blocks of the system.

In order to resolve the aforementioned problems, the assets trading system according to the present disclosure is a platform that 1) is based on real assets that have substantial tangible and intangible security values in order to secure the stability of assets, 2) digital-tokenizes the assets and issues the tokens for the convenience of trading, 3) provides independent individual platforms that enable trading by block chain technology for the stability and security of trading, 4) establishes a system that anonymously calls and connects each digital token holder and potential purchaser in order to resolve stagnation of sales of falling into the state where there is no potential seller or purchaser due to the characteristics of the real asset and thus trading stops for a long period of time, 5) operates a trust that secure professional evaluation on assets and trading assets as collateral to guarantee real asset values of the traders so as to secure reliability of the digital-tokenized assets, 6) generates and trades Real based blockchain bonds (RB3) by which the token holders can possess the distributed bond rights to the real assets and freely trust and trade those rights, 7) controls the initial issuance and approval of the tokens through the trust to prevent the digital-tokenized assets from being hacked and operates the token issuance servers separately so that even if one possesses a majority or more of the tokens the block trading ledgers cannot be manipulated or hacked as in mining type blockchains, 8) maintains independent servers in order to maintain the public characteristics of real assets having substantial values, thereby overcoming the limitations of a POW type mining blockchain where if there is no reward such as coins regarding the node participating in a blockchain system there is a risk of participants breaking away from the system and leading to destruction of the system.

That is, a purpose of the present disclosure is to provide an assets trading system and method capable of providing an opportunity where multiple people can participate in investment by issuing tokens secured with stability based on real assets and of securing trading stability of the tokens by using the blockchain technology.

Furthermore, another purpose of the present disclosure is to provide an assets trading system and method for resolving the trading stagnation phenomenon of the tokens issued through a token holder call system that supports token tradings among parties.

In order to achieve the aforementioned purposes, there is provided an assets trading system among parties through tokenization of assets including an asset evaluation server for evaluating a value of an asset and computing an evaluated amount of the asset; an asset liquidization server for issuing a token corresponding to the computed evaluated amount, and managing rights and dividends regarding the issued token; a token trading bulletin board providing a token trading bulletin board where a potential seller intending to sell the issued token and a potential purchaser intending to purchase the issued token can directly trade with each other, wherein the token trading bulletin board posts a selling notice written by the potential seller or a purchasing notice written by the potential purchaser, and the selling notice includes a name of the asset corresponding to the token to be sold, wallet address of the potential seller, per unit offer price of the token to be sold, amount of the tokens to be sold and a potential seller call window for delivering a purchasing intention to the potential seller, and the purchasing notice includes a name of the asset corresponding to the token to be purchased, wallet address of the potential purchaser, per unit offer price of the token to be purchased, amount of the tokens to be purchased, and a potential purchaser call window for delivering a selling intention to the potential purchaser, an escrow server for mediating sales of the token between the potential seller and the potential purchaser; and a blockchain possessed server having a blockchain for certifying trading of the token and where trading information regarding the certified trade is recorded.

Preferably, the token trade server may have the blockchain where the trading information regarding the trading of the token is recorded, and transmit per unit sales price information of the token included in the trading information recorded in the blockchain to the asset evaluation server, and the asset evaluation server may renew previously evaluated amount of the asset based on the transmitted per unit sales price information of the token.

Preferably, the asset liquidization server may issue the token regarding only remaining shares excluding shares corresponding to a real ownership of an entirety of shares of the asset, and the share corresponding to the real ownership are set to correspond to 51% of the entirety of shares of the asset.

Preferably, the token trading server may transmit a change in shares in accordance to the trading of the token to the asset liquidization server, and the asset liquidization server may determine whether or not there is change in the real ownership of the asset based on the transmitted change in shares, and if there is change in the real ownership of the asset, proceed a registration procedure regarding the changed real ownership.

Preferably, the token trading server may provide a token situation bulletin board that includes detailed information on the token and an asset situation bulletin board that includes detailed information on the asset corresponding to the token, together with the token trading bulletin board, the token situation bulletin board may include a name of the token, name of the asset corresponding to the token, issuance price of the token, current market price of the token, issuance amount of the token and a total asset of the asset corresponding to the token, and the asset situation bulletin board may include a name of the asset corresponding to the token, real market price of the asset, asking price of the asset and link information of news related to the asset.

The present disclosure may provide an assets trading system and method capable of providing an opportunity where multiple people can participate in investment by issuing tokens secured with stability based on real assets and of securing trading stability of the tokens by using the blockchain technology.

The present disclosure may provide an assets trading system and method for resolving the trading stagnation phenomenon of the tokens issued through a token holder call system that supports token tradings among parties.

The present disclosure may configure a system where an individual can issue unique digital tokens based on tangible and intangible real assets, configure a platform that enables independent tradings of the unique issued tokens, and gathers the configured independent platform and mediates tradings of the multiple independent tokens.

### BRIEF DESCRIPTION OF THE DRAWINGS

FIG. 1 is a view that illustrates a configuration of an assets trading system among parties through tokenization of assets according to an embodiment of the present disclosure;

FIG. 2 is a view that illustrates a configuration of a token trading bulletin board being provided by a token trading server according to an embodiment of the present disclosure;

FIG. 3 is a view that illustrates a configuration of a user interface being provided in a token trading process according to an embodiment of the present disclosure;

FIG. 4 is a view that illustrates a configuration of a token situation bulletin board and an asset situation bulletin board being provided by the token trading server according to an embodiment of the present disclosure;

FIG. 5 is a view that illustrates a detailed configuration of an asset liquidization server according to an embodiment of the present disclosure;

FIG. 6 is a view that illustrates an assets trading method among parties through tokenization of assets according to an embodiment of the present disclosure; and

FIG. 7 is a view that illustrates a configuration of a user interface that presents an asset management situation regarding assets being managed by a trust according to an embodiment of the present disclosure.

### DETAILED DESCRIPTION

Hereinafter, with reference to the drawings attached, desirable embodiments of the present disclosure will be explained in more detail. For like configurative elements on the drawings, like reference numerals will be used, and repeated explanation will be omitted for the like configurative elements.

The present disclosure relates to a new assets trading system for making real assets into bonds in the form of tokens to secure stability of the token themselves, for binding all tradings of the tokens with blockchain to secure safety of the token tradings, and then supporting P2P tradings of the tokens. That is, the present disclosure relates to a P2P assets trading system using Real based block chain bonds, for issuing the tokens based on real assets to secure safety, for utilizing the block chain technology by means of a list of tradings and shares of the token holders as evidential means to secure stability, and for securing reliability secured with a trust or civil bonds through legal devices in order to guarantee the rights of token holders. Through the present disclosure, it is possible to resolve the instability of the token themselves and the unsafety of the token tradings that have been emerging as prior art problems.

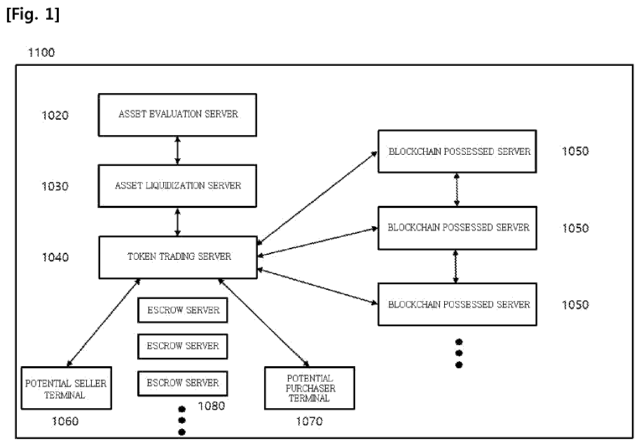

Referring to FIGS. 1 to 5, a configuration of an assets trading system among parties through tokenization of assets according to an embodiment of the present disclosure will be explained hereinafter.

The assets trading system among parties through tokenization of assets according to an embodiment of the present disclosure 1100 may include an asset evaluation server 1020, an asset liquidization server 1030, a token trading server 1040, a blockchain possessed server 1050, a potential seller terminal 1060, a potential purchaser terminal 1070 and/or escrow server 1080.

The asset evaluation server 1020 may evaluate a value of an asset, and compute an evaluated amount of the asset. The asset evaluation server may include a database configured to store and manage market price information of the asset, and may evaluate the value of the asset based on the market price information of the corresponding asset stored in the database. Furthermore, the database of the asset evaluation server may update the market price information of the corresponding asset at every certain period, and the asset evaluation server may re-evaluate the value of the corresponding asset and re-compute a new evaluated amount based on the updated market price information. Furthermore, the assets of which their values are to be evaluated by the asset evaluation server may include intangible assets, real estates, companies, vehicles, ships, art work, and antique etc. Here, the intangible assets may include intellectual property rights, foregift, and portrait rights etc., and the real estates may include profitable real estates such as hotels, shopping complexes, officetels, and parking lots, etc., and margin-type real estates such as apartments, housings and land etc. According to an embodiment, the asset evaluation server can re-evaluate the value of not only the corresponding asset itself but also the tokens regarding the corresponding asset, the asset liquidization server can additionally issue tokens corresponding to the margin profit of the corresponding asset, and the additionally issued tokens can be distributed to shareholders in accordance to existing share ratios. Furthermore, should there be any profit from operation of the asset, it is possible to enable prior selection regarding the profit distribution method and criteria through the trust: for example, cash dividend or new token issuance dividend etc. Furthermore, prices of previously issued tokens may be re-set depending on the rise or fall of the market prices of the corresponding asset.

The asset liquidization server 1030 may issue tokens corresponding to the evaluated amount of the corresponding asset computed by the asset evaluation server 1020, and may manage the rights and dividends regarding the issued tokens. The asset liquidization server may issue only a portion of the corresponding asset as tokens, and may store and manage in the database face values of the tokens, that is the result value of the evaluated amount computed by the asset evaluation server divided by the number of tokens issued. Furthermore, the asset liquidization server may issue tokens only for the shares remaining after excluding the shares corresponding to real ownership from the entirety of shares of the corresponding asset. Here, the shares corresponding to the real ownership of the corresponding asset mean the share ratio of the right of substantially owning the corresponding asset. For example, 51% of the entire shares of the corresponding asset may be set as the share ratio of the real ownership. Furthermore, a person having the shares corresponding to the real ownership of the corresponding asset may register his/her ownership to the corresponding asset. Furthermore, if the corresponding asset is a residential real estate, the asset liquidization server may set the shares corresponding to the real residential right of the entire shares of the corresponding asset, and the shareholder having the shares corresponding to the real residential right may have the right to actually move into the corresponding real estate. Furthermore, when wanting to register the real residential right to the corresponding asset, the corresponding shareholder may request transfer or change of ownership through the trust. According to an embodiment, the shares corresponding to the real ownership and/or real residential right may be traded as a whole instead of being divided and traded.

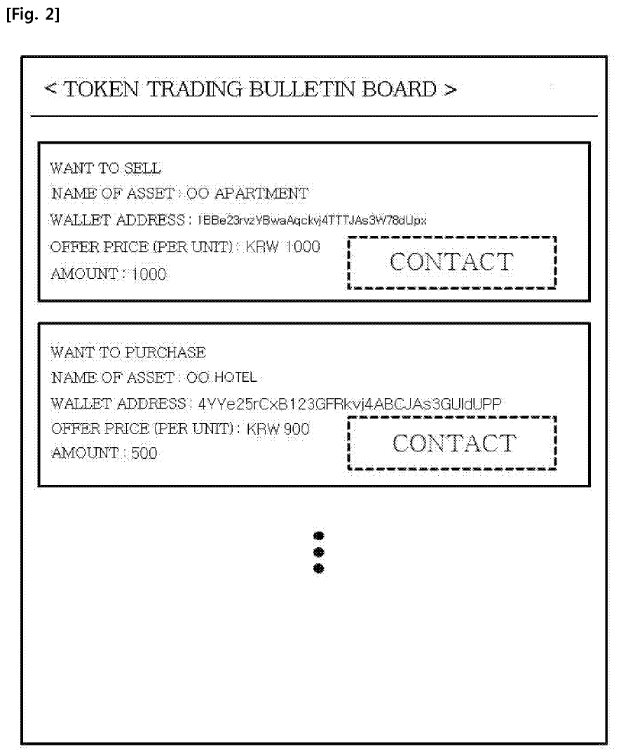

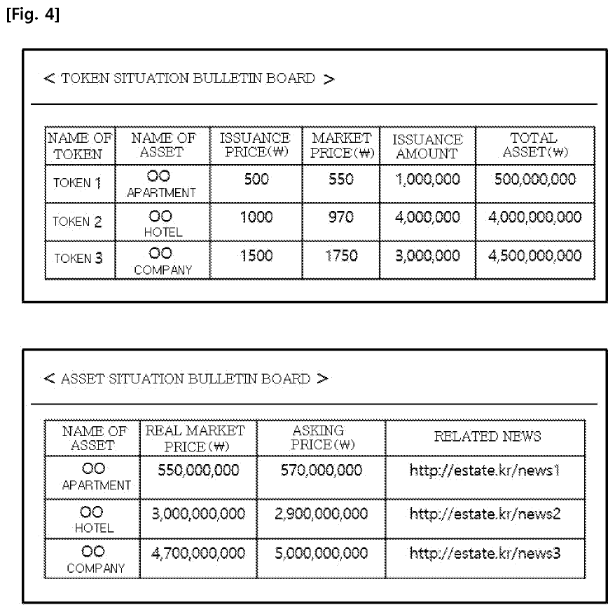

The token trading server 1040 may provide a token trading bulletin board where a potential seller intending to sell the token issued by the asset liquidization server 1030 and a potential purchaser intending to purchase the corresponding token can directly trade with each other. Here, with reference to FIG. 2, the token trading bulletin board being provided by the token trading server may post a selling notice written by the potential seller and/or a purchasing notice written by the potential purchaser. Here, the selling notice may include an asset name corresponding to the token to be sold, wallet address of the potential seller, offer price per each token to be sold, amount of tokens to be sold and/or potential seller call window for delivering an intention to purchase to the potential seller; while the purchasing notice may include an asset name corresponding to the token to be purchased, wallet address of the potential purchaser, offer price per each token to be purchased, amount of tokens to be purchased and/or potential purchaser call window for delivering an intention to sell to the potential purchaser. Here, the token trading server only provides the token trading bulletin for connecting the potential seller and the potential purchaser, and does not purchase or sell the tokens from or to the potential seller and potential purchaser. Referring to FIG. 4, together with the token trading bulletin board, the token trading server may provide a token situation bulletin board that includes detailed information on the tokens and an asset situation bulletin board that includes detailed information on the asset corresponding to the token. Here the token situation bulletin board may include the name of the token, name of the asset corresponding to the token, issuance price of the token, current market price of the token, issuance amount of the token and/or total asset of the asset corresponding to the token, and the asset situation bulletin may include the name of the asset corresponding to the token, real trading price of the asset, asking price of the asset and/or link information of the news related to the asset. Therefore, the potential seller or the potential purchaser may post the selling notice or purchasing notice on the token trading bulletin board while checking in real time the detailed information on the corresponding token and corresponding asset. The token trading server may retrieve detailed information on the corresponding token from the database, retrieve information on a real trading price official notice site as the real trading price information on the corresponding asset, retrieve information posted on a near real estate agent site as the asking price information on the corresponding asset, and retrieve internet article information as the related news on the corresponding asset. Furthermore, the token trading server may provide changes of market price of the corresponding asset, sales history list of the corresponding token, and market price information on similar assets existing near the corresponding asset to the potential seller and/or potential purchaser through the token situation bulletin board and/or asset situation bulletin board. The potential seller and/or potential purchaser may write a notice with reference to the information being provided through the token situation bulletin board and/or asset situation bulletin board.

Referring to FIGS. 2 to 4, to explain specifically about a trading process, the potential seller may approach the token trading bulletin board being provided by the token trading server through an application program of the potential seller terminal 1060. The potential seller may write and upload a selling notice intending to sell the corresponding token on the corresponding token trading bulletin board. Here, the token situation bulletin board posted with detailed information on the tokens being managed by the assets trading system and the asset situation bulletin board posted with detailed information on the assets being managed by the assets trading system may be provided to the potential seller. The potential seller may write a selling notice with reference to the information on the provided token situation bulletin board and the asset situation bulletin board. Here, the selling notice may include contents of intention to sell, name of the asset corresponding to the token to be sold, wallet address of the potential seller, selling offer price, amount and/or potential seller call window for delivering intention of purchase to the potential seller. With the selling notice posted on the token trading bulletin board, the potential purchaser may approach the token trading bulletin board through an application program of the potential purchaser terminal 1070. When the potential purchaser reads the selling notice posted by the potential seller, and intends to purchase the corresponding token as in the contents of the selling notice, it is possible to select the potential seller call window of the selling notice (contact button on FIG. 2). Then, the token trading server may send a selling request signal message to the potential seller (potential seller terminal) through an email, SNS, and text message etc. Here, the email address, SNS address and contact number etc. of the potential seller may be stored and managed in the database of the corresponding assets trading system. The potential seller and the potential purchaser using this assets trading system may subscribe to this system through a member subscription process, and the member information being input here may be stored and managed in the database.

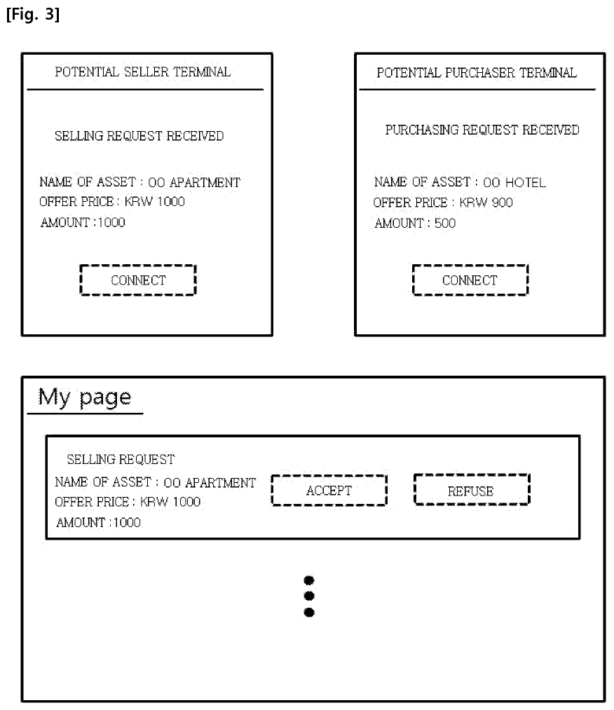

The potential seller may check the selling request signal message through the potential seller terminal, and this selling request signal message may include information on selling the token posted on the token trading bulletin board (name of asset, offer price, and amount etc.). Furthermore, the selling request signal message may include a link window for accessing My page being provided by the token trading server (connecting button on FIG. 3). The potential seller may select the link window to access the My page, and the My page may include detailed contents regarding the corresponding selling request case (name of asset, offer price and amount etc.) and acceptance window for accepting this selling request (acceptance button on FIG. 3) and refusal window for refusal (refusal button on FIG. 3). When the potential seller selects the refusal window, the token trading server may send a message that the corresponding request case has been refused to the potential purchaser through email, SNS, and text message etc., and the corresponding selling request case may be cancelled. When the potential seller selects the acceptance window, a token trading using an escrow server 1080 begins, and the token trading server may deliver the address of the escrow server 1080 corresponding to the trading of the corresponding token to the potential seller and the potential purchaser through email, SNS, and text message etc. The potential seller and the potential purchaser may access the corresponding escrow server through the delivered address of the escrow address, and perform trading of the corresponding token. Specifically, the potential purchaser may deposit a payment (for example, won) in the escrow server, and the potential seller may confirm that the potential purchaser deposited the payment in the escrow server, and then send the corresponding token to the potential purchaser using the wallet address of the potential purchaser. The potential purchaser may confirm receipt of the token and let the escrow server know that the corresponding token has been received well. Then, the escrow server may remit the payment received from the potential purchaser to the potential seller. As the potential seller receives the payment, the corresponding trading may be completed. Here, the assets trading system according to the present disclosure may receive a predetermined commission for mediating the token trading between the potential seller and the potential purchaser. Hereinabove explanation was only about the trading that begins as the potential seller uploads the selling notice, but the trading that begins as the potential purchaser uploads the purchasing notice is also made through the aforementioned trading process, and thus explanation thereon will be omitted.

As aforementioned, the escrow server 1080 may mediate sales of the token between the potential seller and the potential purchaser. In this present disclosure, the escrow server may be allocated per asset. That is, for the trading of the token regarding OO apartment (asset 1), first escrow server may mediate the trading, and for the trading of the token regarding OO hotel (asset 2), second escrow server may mediate the trading. Therefore, tradings of the tokens regarding each asset will not be mixed, and this will help the system run smoothly. Furthermore, since the tokens regarding one asset are all managed by one escrow server, a greater trading safety is secured.

The blockchain possessed server 1050 may certify the trading of the token being made through the aforementioned token trading bulletin board, and have a blockchain where trading information on the certified trading may be recorded. That is, when the trading of the token is accomplished through the aforementioned token trading bulletin board, the potential seller terminal, potential purchaser terminal and/or token trading server may certify through signature that the corresponding trading is a real trading that occurred, and deliver trading information on the corresponding trading (list of tradings or transaction information) to a plurality of blockchain possessed servers 1050, and the plurality of blockchain possessed servers may deliver the corresponding trading information to another blockchain possessed server. Therefore, the trading information on the corresponding trading may be shared by the plurality of blockchain possessed servers, and thus the contents on the corresponding trading may be mutually guaranteed without central control. Here, according to an embodiment of the present disclosure, the potential seller terminal, potential purchaser terminal and/or token trading server may also perform functions as the blockchain possessed server (stores the blockchain as one node of the blockchain). Here, the blockchain possessed server may have the same meaning as the node in blockchain technology.

According to an embodiment of the present disclosure, the token trading server 1040 is a blockchain possessed server as aforementioned, and thus may have a blockchain where trading information on the trading of the token may be recorded. The token trading server may transmit to the asset evaluation server 1020 per unit sales price information on the corresponding token included in the trading information recorded in the corresponding blockchain, and the asset evaluation server 1020 may renew the previously computed evaluated amount of the asset based on the transmitted per unit sales price information on the token.

Furthermore, the token trading server 1040 may figure out changes in shares in accordance to the trading of the token based on the trading information recorded in the blockchain, and transmit the same to the asset liquidization server 1030. The asset liquidization server 1030 may figure out whether or not the real ownership of the corresponding asset changed based on the changes in shares transmitted from the token trading server 1040, and if there has been changes in the real ownership of the corresponding asset, it is possible to proceed with the registration process regarding the changed real ownership,

According to an embodiment of the present disclosure, the price of the token regarding the corresponding asset is determined by the sales price of the potential seller and the potential purchaser, and thus may rise or fall according to the market price of the corresponding asset reflecting favorable factors of the surrounding area etc. Furthermore, in the case where the corresponding asset is a profitable asset such as a commercial complex, and hotel etc., any profit from operating the profitable asset may be distributed to the shareholders in accordance to the current share ratio of the corresponding asset at every certain period.

According to another embodiment, in the case where the price of the token regarding the corresponding asset cannot reflect the market price of the corresponding asset, the asset evaluation server 1020 may re-evaluate the value of the corresponding asset based on the market price information on the corresponding asset being provided through the database. Furthermore, the asset liquidization server 1030 may calculate the margin between the renewed evaluated price and the existing evaluated price, and distribute the margin to shareholders in accordance with the current share ratio of the corresponding asset. Here, the token corresponding to the margin may be newly issued or the newly issued token may be distributed to the shareholders.

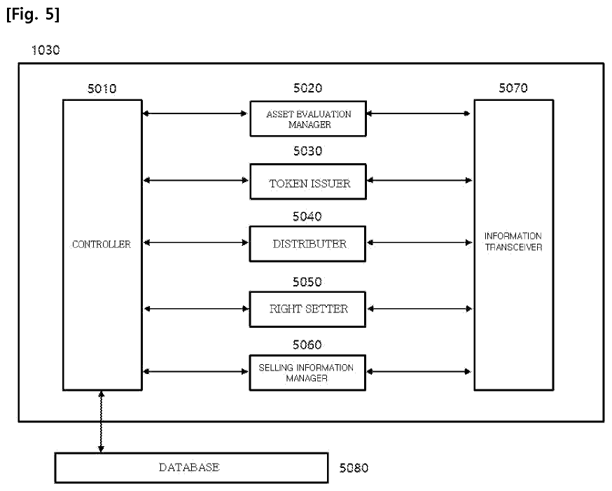

FIG. 5 is a view that illustrates a detailed configuration of the asset liquidization server 1030 according to an embodiment of the present disclosure.

The asset liquidization server 1030 according to an embodiment of the present disclosure may include a token issuer 5030, asset evaluation manager 5020, distributer 5040, right setter 5050, selling information manager 5060, information transceiver 5070 and/or controller 5010.

The asset evaluation manager 5020 may operate in an interlocked manner with the asset evaluation server 1020 and store and manage the value information on the corresponding asset in the database.

The token issuer 5030 may issue the token corresponding to the evaluated amount of the corresponding asset being managed in the asset evaluation manager.

The right setter 5050 may set the share corresponding to the real ownership of the corresponding asset and may request or proceed the ownership registration procedure regarding the corresponding asset to the shareholder having the real ownership according to the pre-set share. Furthermore, the right setter may set the share corresponding to the real residential right of the entire shares of the corresponding asset and may request or proceed the residential right registration procedure to the shareholder having the real residential right according to the pre-set share. According to an embodiment, the token trading server 1040 may provide information on a right relationship regarding the asset regarding the token that is the trading subject to the potential seller and/or potential purchaser through the token trading bulletin board. Here, the virtual currency trading server may request an inquiry of the right relationship regarding the corresponding asset to the right setter, and the right setter may make such an inquiry of the right relationship regarding the corresponding asset and provide the same to the token trading server. Here, the information on the right relationship of the corresponding asset may be stored and managed in the database. Furthermore, it is possible to determine whether or not there are changes in the real ownership of the corresponding asset based on the share changes transmitted from the token trading server 1040, and if there has been any changes in the real ownership of the corresponding asset, it is possible to proceed a registration process regarding the changed real ownership.

The selling information manager 5060 may receive trading information on the token from the token trading server 1040. The corresponding trading information is information recorded in the blockchain, and may include seller information, purchaser information, offer price of the seller offer price of the purchaser, sales price, price per unit of the token sold, and number of the token sold etc. The aforementioned information may be stored in the database, and the selling information manager may provide this information to the token trading server as a trading history in accordance to the request of the token trading server 1040, and the token trading server may deliver this information to the potential seller and/or potential purchaser through the token trading bulletin board.

The distributer 5040 may calculate the margin between the renewed evaluated amount and the existing evaluated amount of the corresponding asset, and distribute the corresponding margin to the shareholders in accordance to the current share ratio of the corresponding asset. Furthermore, it is possible to distribute the operation profit of the profitable asset to the shareholders in accordance to the share ratio.

The controller 5010 may manage the movements of the aforementioned configurations, and the information transceiver 5070 may perform information exchange with external servers.

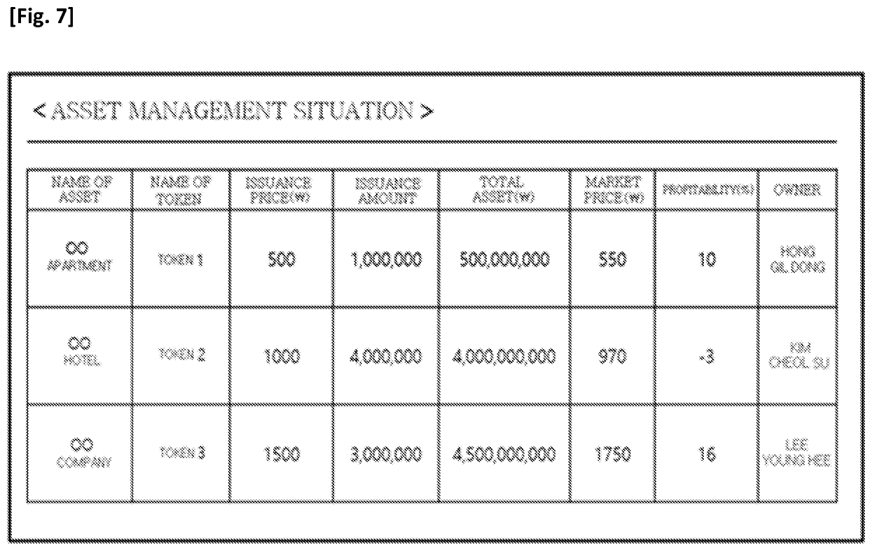

According to an embodiment of the present disclosure, the assets trading system among parties through tokenization of assets may provide the asset management situation on the assets being managed by the trust to the potential seller and/or potential purchaser. Here, with reference to FIG. 7, the asset management situation may include the name of asset, name of the token regarding the corresponding asset, issuance price of the corresponding token, issuance amount, total assets of the corresponding assets, current market price of the corresponding token, profitability considering the current market price compared to the issuance price of the corresponding token, and information on the current manager of the corresponding asset etc. Such information on the asset management situation may be provided through a display of a terminal of a user (including potential seller and potential purchaser).

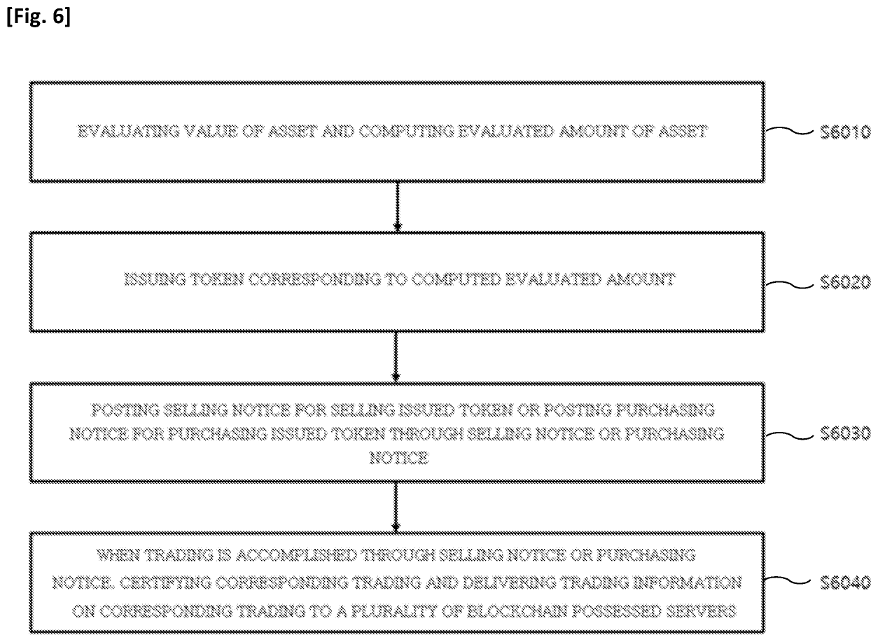

FIG. 6 is a view that illustrates a flowchart of an assets trading method among parties through tokenization of assets according to an embodiment of the present disclosure.

The assets trading method among parties through tokenization of assets according to an embodiment of the present disclosure may include evaluating a value of an asset and computing an evaluated amount of the asset (S6010), issuing a token corresponding to the computed evaluated amount (S6020), posting by a potential seller or a potential purchaser a selling notice for selling the issued token or a purchasing notice for purchasing the issued token through the token trading bulletin board (S6030) and/or when a trading is achieved through the selling notice or the purchasing notice, certifying the corresponding trading and delivering trading information on the corresponding trading to a plurality of blockchain possessed servers (S6040).

Detailed explanation on each of the aforementioned was mentioned above with reference to FIGS. 1 to 4.

As aforementioned, the present disclosure relates to a new assets trading system for making real assets into bonds in the form of tokens to secure stability of the tokens themselves, for binding all tradings of the tokens with blockchain to secure safety of the token tradings, and then supporting P2P tradings of the tokens. That is, it relates to a P2P asset trading system using Real based block chain bonds. Through the present disclosure, it is possible to resolve the instability of the tokens themselves and the unsafety of the token tradings that have been emerging as prior art problems.

In the present specification, the asset evaluation server, asset liquidization server, token trading server, blockchain possessed server, escrow server, controller, asset evaluation manager, token issuer, distributer, right setter, selling information manager and/or information transceiver may be processors that execute sequential processes stored in a memory, or otherwise, operate as software modules driven and controlled by processors. Furthermore, the processor may be a hardware device.

The assets trading method among parties through tokenization of assets according to an embodiment of the present disclosure may be realized in the form of program commands that may be performed through various computer means and recorded in computer readable media. The computer readable media may include a program command, data file and data structure solely or in combinations. The program commands that may be recorded in the above media may be those specially designed and configured for the present disclosure or those well known to those skilled in the computer software field and made available. Examples of the computer readable media include magnetic media such as hard disk, floppy disk and magnetic tape; optical recording media such as CD-ROM and DVD; magneto optics media such as floptical disk; and hardware devices such as ROM, RAM, flash memory that are configured to store and perform program commands. Examples of program commands include not only machine codes such as those made by compilers but also high-level language codes that can be executed by computers using interpreters and the like. The aforementioned hardware devices may be configured to operate as one or more software modules to perform the operations of the present disclosure, and vice versa.

The scope of protection of the present disclosure is not limited to the disclosure and expressions of the examples explicitly explained above. Furthermore, it is to be noted that the scope of protection of the present disclosure cannot be limited due to any changes or substitutions that are obvious in the technical field that the present disclosure belongs to.

What is claimed is:

1. An assets trading system among parties through tokenization of assets comprising:
an asset evaluation server for evaluating a value of an asset and computing an evaluated amount of the asset;
an asset liquidization server for issuing a token corresponding to the computed evaluated amount, and managing rights and dividends regarding the issued token;
a token trading bulletin board providing a token trading bulletin board where a potential seller intending to sell the issued token and a potential purchaser intending to purchase the issued token can directly trade with each other,
wherein the token trading bulletin board posts a selling notice written by the potential seller or a purchasing notice written by the potential purchaser, and the selling notice includes a name of the asset corresponding to the token to be sold, wallet address of the potential seller, per unit offer price of the token to be sold, amount of the tokens to be sold and a potential seller call window for delivering a purchasing intention to the potential seller, and the purchasing notice includes a name of the asset corresponding to the token to be purchased, wallet address of the potential purchaser, per unit offer price of the token to be purchased, amount of the tokens to be purchased, and a potential purchaser call window for delivering a selling intention to the potential purchaser,
an escrow server for mediating sales of the token between the potential seller and the potential purchaser; and
a blockchain possessed server having a blockchain for certifying trading of the token and where trading information regarding the certified trade is recorded.

2. The system according to claim 1,
wherein the token trade server has the blockchain where the trading information regarding the trading of the token is recorded, and transmits per unit sales price information of the token included in the trading information recorded in the blockchain to the asset evaluation server, and the asset evaluation server renews previously evaluated amount of the asset based on the transmitted per unit sales price information of the token.

3. The system according to claim 1,
wherein the asset liquidization server issues the token regarding only remaining shares excluding shares corresponding to a real ownership of an entirety of shares of the asset, and the shares corresponding to the real ownership are set to correspond to 51% of the entirety of shares of the asset.

4. The system according to claim 3,
wherein the token trading server transmits a change in shares in accordance to the trading of the token to the asset liquidization server, and the asset liquidization server determines whether or not there is change in the real ownership of the asset based on the transmitted change in shares, and if there is change in the real ownership of the asset, proceeds a registration procedure regarding the changed real ownership.

5. The system according to claim 1,
wherein the token trading server provides a token situation bulletin board that includes detailed information on the token and an asset situation bulletin board that includes detailed information on the asset corresponding to the token, together with the token trading bulletin board,
the token situation bulletin board includes a name of the token, name of the asset corresponding to the token, issuance price of the token, current market price of the token, issuance amount of the token and a total asset of the asset corresponding to the token, and
the asset situation bulletin board includes a name of the asset corresponding to the token, real market price of the asset, asking price of the asset and link information of news related to the asset.
